(19) United States
(12) Patent Application Publication
(10) Pub. No.: US 2002/0182722 A1
(43) Pub. Date: Dec. 5, 2002

(54) Apparatus and methods for extracting biomass

(76) Inventors: Stuart Corr, Appleton (GB); Robert E. Low, Northwich (GB); Frederick Thomas Murphy, Fordsham (GB); James David Morrison, Northwich (GB)

Correspondence Address: Andrew G. Kolomayets, Cook, Alex, McFarron, Manzo,, Cummings & Mehler, Ltd., 200 West Adams Street - #2850, Chicago, IL, 60606, US

(21) Appl. No.: 10/083,974

(22) Filed: Feb. 27, 2002

Related U.S. Application Data
(63) Continuation of application No. PCT/GB00/03390, filed on Sep. 4, 2000.

(30) Foreign Application Priority Data
Sep. 6, 1999 (GB) 9920945.4

(51) Int. Cl. C12M 1/26

(52) U.S. Cl. 435/309.1; 422/288

(57) ABSTRACT

A closed loop apparatus (10) for extracting biomass includes an evaporator (42) and a condenser (43) directly connected to one another, without an intermediate compressor. An optional pump (14) moves liquid solvent between the evaporator (42) and compressor (43) and provides a hydrostatic head for the closed loop circuit.

### CROSS REFERENCE TO RELATED APPLICATION

This application is a continuation of pending International Application No. PCT/GB00/03390, filed Sep. 4, 2000 and published in English.

This invention concerns apparatuses and a method for “extraction” of biomass. This is the extraction of flavours, fragrances or pharmaceutically active ingredients from materials of natural origin (these materials being referred to as “biomass” herein).

### BACKGROUND OF THE INVENTION

Examples of biomass materials include but are not limited to flavoursome or aromatic substances such as coriander, cloves, star anise, coffee, orange juice, fennel seeds, cumin, ginger and other kinds of bark, leaves, flowers, fruit, roots, rhizomes and seeds. Biomass may also be extracted in the form of biologically active substances such as pesticides and pharmaceutically active substances or precursors thereto, obtainable e.g. from plant material, a cell culture or a fermentation broth.

There is growing technical and commercial interest in using near-critical solvents in such extraction processes. Examples of such solvents include liquefied carbon dioxide or, of particular interest, a family of chlorine-free solvents based on organic hydrofluorocarbon species.

By the term “hydrofluorocarbon” we are referring to materials which contain carbon, hydrogen and fluorine atoms only and which are thus chlorine-free.

Preferred hydrofluorocarbons are the hydrofluoroalkanes and particularly the C₁₋₄ hydrofluoroalkanes. Suitable examples of C₁₋₄ hydrofluoroalkanes which may be used as solvents include, inter alia, trifluoromethane (R-23), fluoromethane (R-41), difluoromethane (R-32), pentafluoroethane (R-125), 1,1,1-trifluoroethane (R-143a), 1,1,2,2-tetrafluoroethane (R-134), 1,1,1,2-tetrafluoroethane (R-134a), 1,1-difluoroethane (R-152a), heptafluoropropanes and particularly 1,1,1,2,3,3,3-heptafluoropropane (R-227ea), 1,1,1,2,3,3-hexafluoropropane(R-236ea), 1,1,1,2,2,3-hexafluoropropane (R-236cb), 1,1,1,3,3,3-hexafluoropropane (R-236fa), 1,1,1,3,3-pentafluoropropane (R-245fa), 1,1,2,2,3-pentafluoropropane (R-245ca), 1,1,1,2,3-pentafluoropropane (R-245eb), 1,1,2,3,3-pentafluoropropane (R-245ea) and 1,1,1,3,3-pentafluorobutane (R-365mfc). Mixtures of two or more hydrofluorocarbons may be used if desired.

R-134a, R-227ea, R-32, R-125, R-245ca and R-245fa are preferred.

An especially preferred hydrofluorocarbon for use in the present invention is 1,1,1,2-tetrafluoroethane (R-134a).

It is possible to carry out biomass extraction using other solvents, such as chlorofluorocarbons (“CFC×”) or hydrochlorofluorocarbons (“HCFC 's”) and/or mixtures of solvents. CFC's and HCFC's are not approved for biomass extractions whose products are intended e.g. for food or medicine uses.

Known extraction processes using these solvents are normally carried out in closed-loop extraction equipment. A typical example 10 of such a system is shown schematically in FIG. 1.

In this typical system, liquefied solvent is allowed to percolate by gravity in downflow through a bed of biomass held in vessel 11. Thence it flows to evaporator 12 where the volatile solvent vapour is vaporised by heat exchange with a hot fluid. The vapour from evaporator 12 is then compressed by compressor 13. The compressed vapour is next fed to a condenser 14 where it is liquefied by heat exchange with a cold fluid. The liquefied solvent is then optionally collected in intermediate storage vessel (receiver) 15 or returned directly to the extraction vessel 1 to complete the circuit.

A feature of this process is that the principal driving force for circulation of solvent through the biomass and around the system is the difference in pressure between the condenser/storage vessel and the evaporator. This difference in pressure is generated by the compressor. Thus to increase the solvent circulation rate through the biomass it is necessary to increase this pressure difference, requiring a larger and more powerful compressor.

The large difference in solvent liquid and vapour densities means that a modest increase in liquid circulation rate can require significant additional capital and operating cost because of this increase in compressor size. This means that the system designer has to compromise between the rate at which liquid can be made to flow through the biomass and the rate at which vapour can be compressed.

The basic vapour compression/extraction process described above works well if the solvent fluid being used also has a good balance of thermophysical properties for use as a working fluid in a refrigeration/heat pump cycle. There are however several disadvantages to the use of such a cycle, even if the solvent properties make it an attractive refrigerant working fluid.

The principal drawback to use of the above process is the need to use a compressor. For many of the commercially attractive extracts the end use is as an ingredient of a food, personal care product or medicine. Contamination of the extract with compressor lubricating oil is therefore unacceptable. Although it is possible to obtain some food-grade lubricant materials, if used in a conventional compressor these will still contaminate and dilute the extract to some degree. The safe solution (especially in designing a multi-purpose batch extraction plant) is to use a special design of compressor which either does not use lubricating oil or enforces a rigorous physical seal between any oiled parts and the fluid being compressed.

It is possible to obtain such machines; however they are expensive. The materials of construction used for such machines are typically stainless steel with PTFE-based seals, which means that these units are significantly more expensive than conventional, mass-produced refrigeration compressors. Therefore the capital cost implications for a process designer are significant.

If furthermore the solvent being used has a high vapour pressure (for example liquefied carbon dioxide) then there are further capital cost implications because the compressor may need to be a multi-stage device. The variable (operating) cost of using the process will also increase as the pressure difference over the compressor increases.

Finally, the use of the vapour compression/extraction process outlined above will normally require that the process be fitted with a pressure relief device, to protect against the accidental over-pressure of the system by maloperation of the equipment with e.g. the compressor operating against a closed system. This requires that the relief device be vented to a safe location and there is always then potential for loss of charge through the relief stream, with a consequent loss of production time and cost of replacing the solvent, cleaning the system etc., as well as the potential environmental hazards associated with discharging solvents and extract/solvent mixtures from the apparatus.

According to a first aspect of the invention there is provided apparatus for extracting biomass comprising a closed loop circuit including, operatively connected in series, an extraction vessel, for containing biomass, that permits the solvent or a solvent mixture to contact biomass to effect extraction; an evaporator for separating solvent and biomass extract from one another; a condenser for condensing solvent evaporated in the condenser; and a means for moving liquid solvent from the condenser to the extraction vessel and to the evaporator, without compressing a vapor phase.

An advantage of this arrangement is that the absence of a compressor permits the design of a circuit whose design pressure could be selected to cope with the maximum attainable vapour pressure in the system, removing the need for external pressure relief devices; or at least minimising the frequency and reducing the magnitude of relief events.

In one embodiment of the invention the extraction vessel, evaporator and condenser are discrete components operatively interconnected by a pipework circuit.

In other embodiments of the invention the evaporator and condenser are contained within the same vessel, sometimes referred to as a “short-path still”. Preferred arrangements of the short-path still type of vessel are described and claimed in published International Application No. PCT/GB00/03390, filed Sep. 4, 2000, which is incorporated herein by reference and are embodied in (1) an apparatus in accordance with the first aspect described above wherein the evaporator and condenser are constituted as parts of the same evaporator/condenser vessel, and the extraction vessel is a discrete component operatively connected to the evaporator/condenser vessel by a pipework circuit; (2) an apparatus in accordance with embodiment (1) above wherein the evaporator/condenser vessel is a generally closed, hollow vessel having lower and upper interior zones spaced from one another, the lower zone including the evaporator and the upper zone including the condenser; (3) an apparatus in accordance with embodiment (2) above wherein the lower zone includes a feed thereinto for liquid solvent/extract mixture; a heat source for heating the liquid solvent/extract mixture to evaporate the solvent from the extract; and a drain for draining liquid extract out of the condenser/evaporator vessel; (4) an apparatus in accordance with embodiment (3) above wherein the heat source is or includes a heating jacket or a member secured onto or surrounding a portion of the exterior of the condenser/evaporator vessel adjacent or corresponding to the lower zone; (5) an apparatus in accordance with embodiment (2) above or any embodiment incorporating the same wherein the upper zone includes a cooler that cools one or more surfaces in the upper zone; a receptacle lower than the surface and located to catch liquid solvent, condensed onto the surface, that falls from th surface under gravity; and a drain for draining liquid solvent from the receptacle; (6) an apparatus in accordance with embodiment (5) above wherein the cooler includes a jacket or member secured onto or surrounding a portion of the exterior of the vessel adjacent or corresponding to the upper zone, an interior wall of the upper zone, cooled by the cooling jacket or member, being or including the said surface and the receptacle including a tray protruding from the said wall inside the vessel; (7) an apparatus in accordance with embodiment (6) above wherein the upper zone is of cylindrical cross-section and the tray is an annular protruding from and extending about the interior wall of the upper zone; (8) an apparatus in accordance with embodiment (5) above, wherein the cooler includes a cooling member within the upper zone; the cooling member including the said surface; and the receptacle underlying the cooling member; (9) an apparatus in accordance with any of the embodiments (5), (6), (7), (8) above wherein the cooling jacket or member includes one or more internal passages permitting the flow therethrough of a cooling fluid; (10) an apparatus in accordance with any of the embodiments (5), (6), (7), (8), (9) above wherein the drain passes through the wall of the evaporator/condenser vessel and wherein the closed loop circuit includes the lower zone, the upper zone and the drain, operatively connected in series; (11) an apparatus in accordance with embodiment (2) above or any embodiment incorporating the same wherein the lower and upper zones are spaced from one another by a gas permeable, generally liquid impermeable barrier; (12) an apparatus in accordance with embodiment (3) above wherein the heat source is or includes a heating member within the condenser/evaporator vessel; (13) an apparatus in accordance with embodiment (1) above or any embodiment incorporating the same, including a direct heat pump for evaporating and condensing the solvent.

Preferably the means for moving the liquid solvent from the condenser to the extraction vessel as described above, includes a liquid pump operatively connected in series in the closed loop circuit between the condenser and the extraction vessel. Since pumping a liquid requires much less energy than pumping a vapour, the running cost of the pump is much lower than that of the compressor in a typical closed-loop extraction process. The capital cost of the pump will also normally be lower than that of the compressor.

Alternatively or additionally the condenser is at a greater altitude than the extraction vessel and the evaporator, whereby the means for moving liquid solvent between the condenser and the extraction includes the hydrostatic head between the condenser and the extraction vessel.

Conveniently such a gravity flow embodiment includes a liquid lute operatively connected in series with the condenser, on the outlet side thereof. The liquid lute advantageously provides a liquid seal on the outlet side of the condenser and may be used to provide subcooling of the liquid solvent. The liquid lute may not be needed in embodiments in which pump suction entrains liquid from the condenser.

According to a second aspect of the invention there is provided a method of extracting biomass comprising the steps of loading a bed of biomass into an extraction vessel having an inlet and an outlet and forming part of a closed loop circuit including, operatively connected in series, the extraction vessel, an evaporator and a condenser; contacting the biomass with a solvent flowing around the closed loop, whereby biomass extract becomes entrained with the solvent; moving the solvent around the closed loop to the evaporator and evaporating the solvent to separate the solvent and the extract from one another; moving the vaporized solvent around the closed loop to the condenser and condensing it to liquid form, and moving the condensed solvent around the closed loop to the extraction vessel for further contact with biomass therein, wherein the solvent in vapour form is generally uncompressed. This method may conveniently be practised using apparatus as defined herein.

The method may optionally involve gravity flow of the liquid solvent. Alternatively or additionally the method may include pumping the liquid solvent between the condenser and the extraction vessel.

Especially when the method includes pumping of liquid solvent as aforesaid, the method may be such that the steps of evaporating and condensing the solvent take place within the same hollow vessel. Thus this part of the method may suitably take place in a short-path still —as described herein.

The method typically includes the steps of packing biomass in the extraction vessel, thereby achieving a high biomass density.

The method of the invention also includes removal of biomass extract from the evaporator, as desired.

The invention also resides in biomass extract obtained by practising the method(s) defined herein.

There now follows a description of preferred embodiments of the invention, by way of non-limiting example, with reference being made to the accompanying drawings.

### BRIEF DESCRIPTION OF THE SEVERAL VIEWS OF THE DRAWING(S)

FIG. 1 is a schematic representation of a prior art biomass extraction circuit, described herein above;

FIG. 2 is a schematic representation of a first embodiment of apparatus according to the invention;

FIG. 3 is a schematic representation of an embodiment of closed-loop apparatus, according to the invention, in which gravity flow obviates the need for the pump of FIG. 2;

FIG. 4 is a schematic, vertically sectioned view of a first embodiment of short-path still, according to the invention, that may optionally replace some components of the FIG. 2 apparatus;

FIG. 5 is a schematic, vertically sectioned view of a second embodiment of short-path still, that is an alternative to the FIG. 3 still;

FIG. 6 is a Mollier plot (pressure-enthalpy diagram) illustrating the behaviour of the solvent in the stills of FIGS. 4 and 5;

FIG. 7 shows an alternative form of short-path still; and

FIG. 8 shows a biomass extraction circuit including a short-path still and heat regeneration.

### DETAILED DESCRIPTION OF THE INVENTION

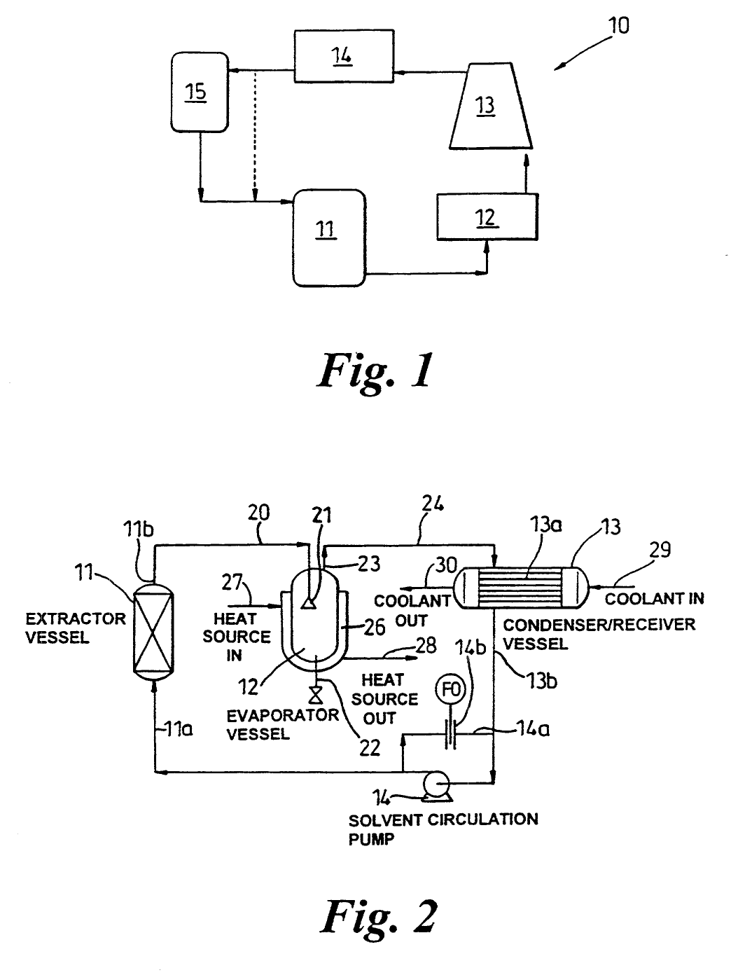

Referring to FIG. 2 there is shown a closed loop biomass extraction circuit according to the invention. The circuit includes, operatively connected in series, an extraction vessel 11 for containing biomass, that permits a solvent or a solvent mixture to contact biomass therein to effect biomass extraction.

Vessel 11 is an elongate, hollow, upright cylinder substantially closed at either end. It includes a solvent inlet 11a at its lower end and a solvent/biomass extract outlet 11b at its upper end.

Outlet 11b is connected via line 20 to evaporator 12. Line 20 supplies a solvent/extract liquor to the interior of evaporator 20, that is a hollow vessel that is substantially closed, via nozzle 21 secured to the terminus of line 20 inside evaporator 12.

As described below, evaporator 12 separates the solvent from the biomass extract. Evaporator 12 has a liquid drain 22 at substantially its lowermost point, and a vapour outlet 23, for solvent in vapour form, at or near its highest point.

Outlet 23 is connected, via line 24, to condenser/receiver vessel 13, in which solvent vapour condenses in use of the apparatus to liquid form. Unlike the prior art arrangement of FIG. 1, the FIG. 2 circuit omits a compressor between the evaporator and the condenser.

Condenser/receiver 13 includes an outlet 13b for liquid solvent. Outlet 13b connects to pump 14 that, in use of the apparatus, pumps liquid solvent to the inlet 1 a of extraction vessel 11. Pump 13 includes an optional solvent recirculation loop 14a including a flow restrictor in the form of orifice plate 14b.

The exterior of evaporator 12 is at least partly surrounded by a heater jacket 26. Heater jacket includes one or more ducts for a warm or hot fluid, that is supplied to jacket 26 via inlet pipe 27 and that exits via outlet pipe 28. The hot fluid circulates around jacket 26 in use of the apparatus to evaporate solvent in evaporator 12.

Condenser/receiver 13 includes another heat pump, in which a fluid coolant, supplied via inlet 29, circulates in one or more pipes 13a in vessel 13 to cause condensation therein of solvent before exiting the vicinity of condenser/receiver vessel 13 via outlet pipe 30.

Before use of the FIG. 2 apparatus, the extraction vessel 11 is charged with a bed of biomass; and the circuit filled to a requisite level with solvent such as 1,1,1,2-tetrafluoroethene.

The operation of the FIG. 2 arrangement is similar to the process outlined above in relation to FIG. 1, except that solvent vapour is led directly to condenser unit 13 which is fed with a cold coolant fluid. The condensed solvent is then circulated by pump 14 back to the extractor vessel, thence to the evaporator. During this process the solvent removes extract from the vessel 11 and entrains it to the evaporator 12.

During or after operation of the apparatus the biomass extract is drained from the evaporator 12, for subsequent further commercial processing.

Solvent vapour, evaporated from the solvent/extract mixture in evaporator 12 is condensed in condenser/receiver 13 and then pumped to extraction vessel 11 for further contact with biomass therein.

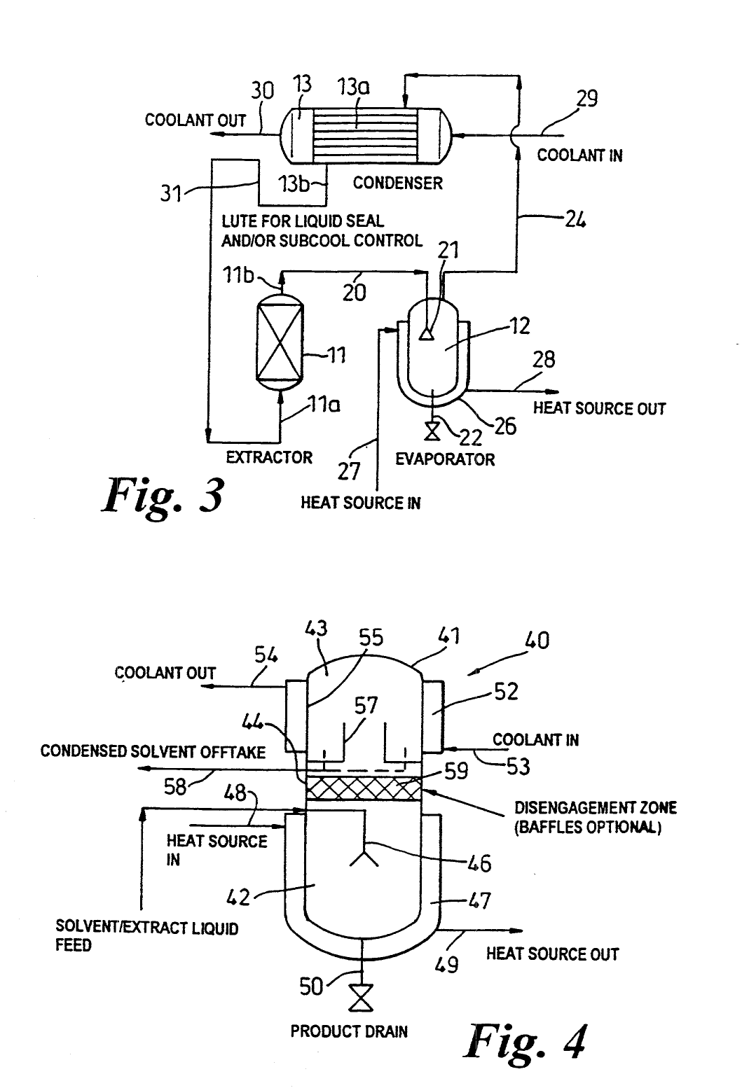

An alternative embodiment, obviating the need for pump 14, is shown in FIG. 3. Thus in this embodiment a gravity flow arrangement is used. The circulation rate of the solvent is then determined by the net hydrostatic head available between the condenser and evaporator. This design may be preferred for larger scale equipment where the physical size of equipment means that an elevated structure will be used in any event.

In FIG. 3 the extraction vessel 11, evaporator 12 and condenser 13 are substantially the same as in the FIG. 2 embodiment. The components shown in both FIGS. 2 and 3 function in essentially the same way as between the two embodiments, and are not therefore described again in relation to FIG. 3. Pump 14 is omitted because condenser 13 is raised relative to the remainder of the closed loop circuit. The resulting net hydrostatic head is sufficient in use of the FIG. 3 apparatus to supply liquid solvent to and through the biomass, and to the nozzle 21 in evaporator 12.

The FIG. 3 embodiment includes a fluid lute 31 formed in the outlet pipework connecting the condenser 13 and extraction vessel 11. The fluid lute 31 ensures a liquid seal on the outlet side of condenser 13 and may be used for subcooling the solvent therein.

In both the FIG. 2 and FIG. 3 embodiments the energy efficiency of the cycle can be greatly improved by using an external heat pump device. (Either vapour compression or absorption cycle devices are suitable.) This could be used with a direct arrangement (with the working fluid of the heat pump acting as the condenser cooling medium and the evaporator heating medium) or could be used with a secondary coolant circuit. If for example the chosen working fluid for the heat pump were not of food/medical purity then added security against tube leakages into the solvent extraction circuit would be offered by using a secondary coolant system of food-grade solvent.

FIG. 4 shows another embodiment of the invention. This combines the evaporation and condensation steps within a single vessel. The vessel is then acting as a single stage still; this is an example of so-called “short-path” distillation. The short-path still 40 of FIG. 4 may be connected into at least the FIG. 2 circuit in place of the evaporator 12, condenser 13 and the pipework associated with these components.

The vessel 41 defining the short-path still is an upright, hollow, substantially closed cylinder having lower 42 and upper 43 interior zones spaced vertically from one another by a disengagement zone 44.

The lower zone 42 includes an evaporator stage and the upper zone 43 a condenser.

The lower zone includes a feed 46 thereinto for liquid/solvent extract mixture; a heat source (such as external heater jacket 47, having internal fluid circulation pipes); warm/hot fluid inlet and outlet pipes 48, 49 and a drain 50 for collection of biomass extract from the evaporator stage.

The condenser in the upper zone 43 includes a cooler in the form of external cooling jacket 52 having internal fluid coolant pipes and coolant fluid inlet and outlet pipes 53,54.

In use the cooler cools a surface of the upper zone, this in the FIG. 4 being the interior wall 55 of upper zone 43. A receptacle in the form of annular tray 57 is for collecting condensed solvent from the wall 55 at the bottom of upper zone 43. A solvent drain 58 drains liquid solvent from the receptacle for supply to extraction vessel 11 via pump 14.

During operation of a circuit including the short-path still 40 of FIG. 4, the solvent evaporation stage takes place in lower zone 42 of the vessel. Solvent vapour rises and flows through disengagement zone 44 (where the vapour velocity is sufficiently low to prevent droplet entrainment) and then passes through a vapour gap (or gaps) to the upper zone 43 of the vessel. The condensed solvent is collected in a tray 57. Liquid solvent is then drawn off the tray as required and returned to the extraction system.

The disengagement zone can be an empty vessel section or optionally may include a gas permeable, generally liquid impermeable barrier such as baffles or wire mesh 59 to discourage any liquid entrainment. The liquid offtake from the condenser storage tray 57 can be led through a lute if desired to provide a liquid seal for the system.

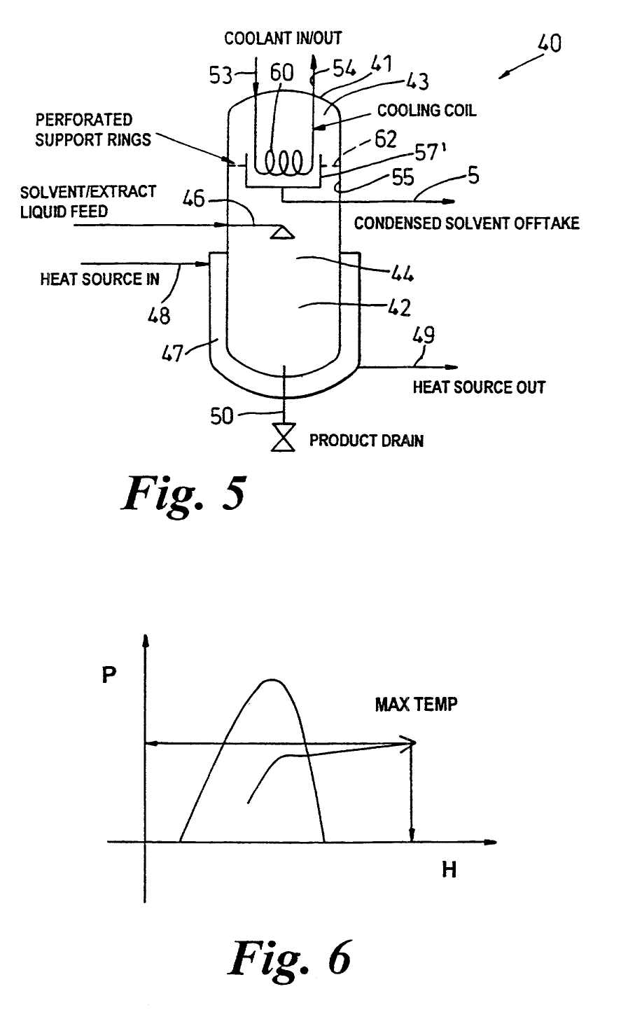

An alternative short-path still is shown in FIG. 5, where in place of a cooling jacket an internal cooling coil 60 is employed, the other principles shown in FIG. 4 being unaltered. This arrangement may allow for different coolants to be employed according to need and could also offer a way of using a large surface area for the condenser in a compact space.

The FIG. 5 arrangement includes a cup-like receptacle 57′ under the centrally suspended cooling coil 16. The receptacle 57′ is supported on one or more perforated support rings 62 interconnecting the receptacle 57′ and inner wall 55. The support rings permit the flow of gaseous solvent into upper zone 43.

In FIG. 5 the surface onto which the solvent condenses is of course the outer surface of coil 60, hence the modified shape and location of the receptacle 57′.

Another form of short-path still, according to the invention, is shown in FIG. 7.

This embodiment employs the cooling coil 60 of FIG. 5, but the still cylinder 41 is more elongate than the FIGS. 4 and 5 embodiments.

The receptacle of FIGS. 4 and 5 is in FIG. 7 replaced by an elongate tube 65 extending parallel to and concentric with cylinder 41.

In use the solvent/extract mixture delivered by pipe 48 and nozzle 21 is heated in lower zone 42, as signified schematically by arrows H. Solvent vapour rises in the cylinder 41, as illustrated by arrows V in FIG. 7, to upper zone 43. In upper zone 43 the solvent condenses onto the coil 60 and falls into an open funnel 66 secured to the open, upper end of tube 65. Condensed solvent passes down tube 65 and is fed to the remainder of the extraction circuit via pipe 58.

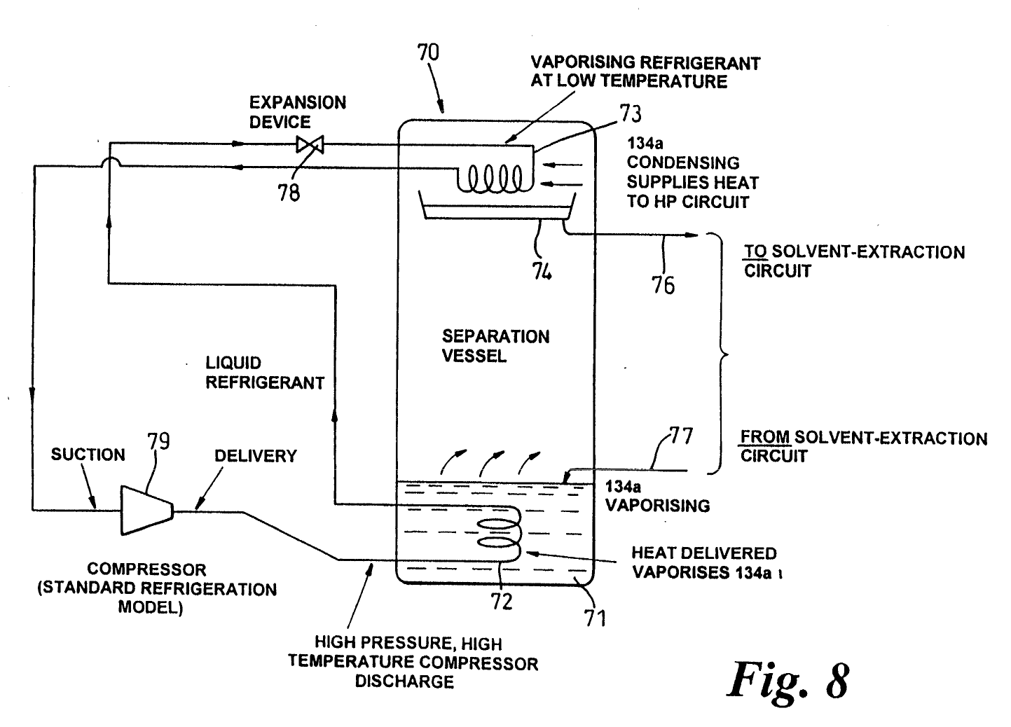

The direct heat pump embodiment is illustrated in FIG. 8. This shows a separation vessel 70 which contains a pool 71 of boiling solvent and extracted oils. The vessel 70 is fitted with two heat exchangers or coils, one 72 situated close to the bottom of the vessel forming a lower heat exchanger and one 73 close to the top of the vessel forming an upper heat exchanger.

The vessel 70 contains a quantity of solvent and extract in solution forming a pool 71 at the bottom by virtue of its density.

The purpose of the lower heat exchanger coil 72 is to provide heat to the pool 71 in order to vaporise the more volatile solvent fraction and thus fill the cavity of the vessel 70 with the vapour so produced.

The purpose of the upper heat exchanger coil 73 is to condense this vapour into liquid form. An open-topped collection vessel 74 is arranged to be below the condensing coil in order to collect solvent condensed on the coil.

Principally pure solvent collected in this way is fed via line 76 to a solvent extraction circuit such as the remainder of the FIG. 2 circuit not constituted by evaporator 12 and condenser 13. From the solvent extractor circuit, a solution of solvent and extract in solution is fed via line 77 from the solvent extraction circuit to the bottom of the separation vessel 70. The heat exchangers are arranged in the vessel such that solvent vapour is produced by the application of heat to the pool 71 of solvent and dissolved extract oil. The vapour fills the vessel 70 and is condensed on the upper heat exchanger principally as pure solvent, to be fed to the solvent extraction circuit via line 76. Solvent and dissolved oil extracts are returned from the solvent extraction circuit to the pool of liquid in the bottom of the extraction vessel so that the process is continuous.

The solvent extraction circuit referred to above may either be an external circuit formed from pipework and components or could be an internal circuit formed in the body of the separation vessel itself. In the latter case the vessel would contain all the components previously described, but would also contain a quantity of raw biomass at approximately its mid section such that the solvent condensed on the upper coil permeated or flowed through the body of the raw biomass, thus extracting the required oils. This solvent and oils mixture would then pass into the pool at the bottom of the vessel. In the case of an internal solvent extraction circuit provision would need to be made to allow the evaporating solvent from the pool to pass freely to the upper heat exchange coil, past the bulk of biomass situated in the vessel mid section as described.

Heat is supplied and extracted from the vessel by means of a separate vapour compression circuit which operates using the two heat exchangers 72, 73 previously described, an expansion device 78 such as a restriction or valve and a standard refrigeration compressor 79. This circuit may be filled with an HFC, CFC, HCFC or similar refrigerant.

High pressure high temperature vapour is supplied to the lower heat exchanger coil 72 in the bottom of the separation vessel by the compressor. The heating coil forms the ‘condenser’ in the refrigeration circuit. Once the refrigerant is condensed into liquid form it is made to pass through an expansion device 78 where it changes state into a two phase liquid vapour mixture at low temperature and pressure. This fluid is fed into the upper heat exchanger coil 73 at the top of the separation vessel in order to condense the 134a solvent. This coil forms the ‘evaporator’ of the separate vapour compression circuit.

From the evaporator the vapour then passes to the low pressure inlet of the compressor 79 where it is compressed to high pressure and temperature, for onward passage to the high temperature coil as before.

The total heat rejected at the upper heat exchanger 73 is approximately equal to the heat supplied to the lower heat exchanger plus the energy input to the compressor. In this way the energy supplied to the system as a whole is effectively minimised.

The vessel 70 in FIG. 8 is thus another example of a short-path still, whose basic operation is similar to that of the FIG. 4 arrangement, and a direct heat pump.

Although use of an external vapour compression heat pump would add to the cost of the process the costs should be lower than using a compressor in the solvent circuit, because it is then possible to use a less expensive, mass produced refrigeration compressor and standard components, with no requirement either for costly materials of construction nor for sophisticated oil management features.

It is in addition possible then to use the optimal refrigerant/working fluid for the heat recovery duty, independent of the solvent desired for the extraction process. This removes the requirement for good solvency and good heat pump cycle efficiency in one and the same solvent.

By using a process of the type described above, especially in the case where a short-path still is used but equally applicable where separate condenser and evaporator vessels are employed, it is possible to protect against system overpressure by intrinsically safe design principles.

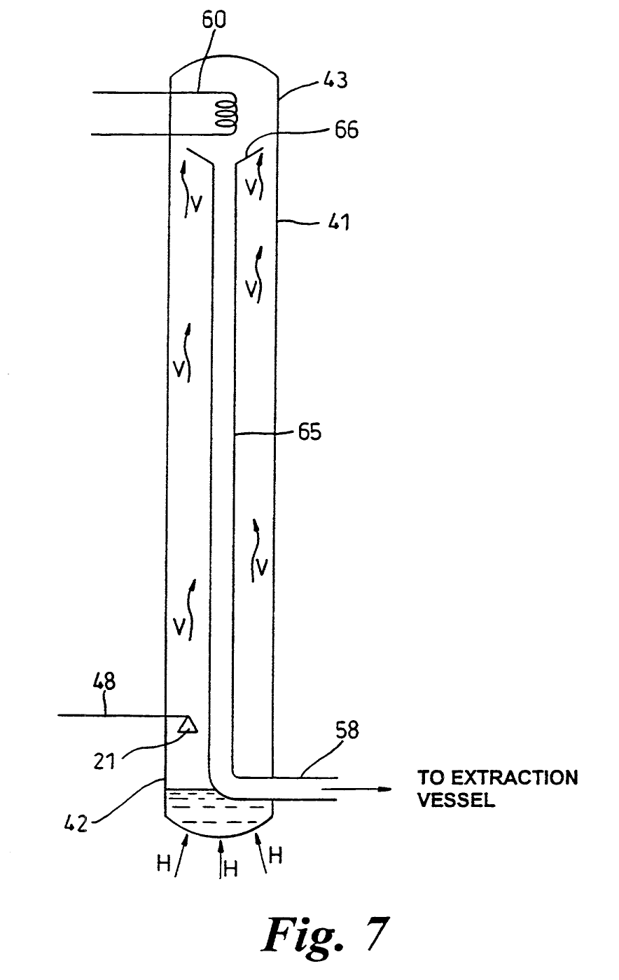

If evaporator and condenser are considered together as a closed system, and there are no valves in the pipework between the vessels, they can be thought of as forming a single containment volume, in which a fixed maximum mass of solvent can be present. This mass is determined by the charge of solvent put into the system. If the evaporator and condenser are isolated from any other vessel then, if the heat supplied by the heating system is not balanced by the heat removed through the cooling system and through natural heat losses, then the pressure will rise in the two vessels. This pressure rise will take place at constant density (since no mass can enter or leave the fixed volume) and it will initially take place in the saturated, two-phase region of the solvent's thermodynamic property map. The pressure will follow a line of constant density (“isochore”) through the two-phase region as shown in FIG. 6.

If a sufficient fraction of the volume in normal operation is vapour (and this can be selected by careful design) then ultimately there will be a point at which the entire liquid inventory has been turned to vapour. As heat is supplied beyond this point the pressure will continue to rise, along the isochore. However because the vapour is now superheated the rate of pressure rise will be greatly lessened. The ultimate pressure attainable will be determined by the maximum temperature of the heat source. If this is water supplied from a tank at atmospheric pressure, for example, the maximum feasible heat supply temperature is 100 C.

The potential benefit of this can be seen by considering 1,1,1,2-tetrafluoroethane (“R-134a”) as the solvent, with warm water as a heat source. If the initial conditions are a vapour volume fraction of 75% and a starting temperature of 20 C, the system density is 36.76 kg/m³ and the normal system pressure would be 5.72 bara. The vapour pressure of R-134a at 100 C is 40 bara. However, the pressure corresponding to a saturated vapour density of 36.76 kg/m³is 7.6 bara (temperature of 29.3 C). The maximum pressure attained (when the vapour temperature is 100 C and the density is 36.76 kg/m³) is only 10.1 bara.

If the above calculation is repeated with a starting vapour volume fraction of 50% then the initial density is 54.3 kg/m³ and the final attained pressure is 14.25 bara.

This principle can be extended to provide complete protection for the system by taking into account the whole liquid inventory of the extractor and associated pipework when sizing the condenser and evaporator vessels.

The intrinsic safety benefit offered by the natural circulation process (i.e. the solvent process without compressor or solvent circulation pump) is thus the ability to select a reasonable design pressure which gives protection against overpressure through heat input without need for costly pressure relief. It also offers potential to reduce the design pressure of the vessels below that indicated by the vapour pressure of working fluid at maximum temperature alone, although the maximum potential liquid fill and hence final attainable pressure of the vessel needs to be allowed for in making this judgement.

In summary, the benefits of the invention are that it: avoids the need for costly oil-free compressor of exotic construction; is a simple system suited to heat integration using inexpensive and optimised heat pump rather than compromising selection of solvent for particular extraction; is a combination of evaporation and condensation in single vessel to save on capital cost of pressure vessels; and is a simple method of providing intrinsic safety through careful selection of process vessel sizes.

What is claimed:

1. Apparatus for extracting biomass comprising a closed loop circuit including, operatively connected in series, an extraction vessel, for containing biomass, that permits the solvent or a solvent mixture to contact biomass to effect extraction;
an evaporator for separating solvent and biomass extract from one another;
a condenser for condensing solvent evaporated in the condenser; and
a means for moving liquid solvent from the condenser to the extraction vessel and to the evaporator, without compressing a vapour phase.

2. Apparatus according to claim 1 wherein the extraction vessel, evaporator and condenser are discrete components operatively interconnected by a pipework circuit.

3. Apparatus according to claim 1 wherein the evaporator and condenser are constituted as parts of the same evaporator/condenser vessel, and the extraction vessel is a discrete component operatively connected to the evaporator/condenser vessel by a pipework circuit.

4. Apparatus according to claim 3 wherein the evaporator/condenser vessel is a generally closed, hollow vessel having lower and upper interior zones spaced from one another, the lower zone including the evaporator and the upper zone including the condenser.

5. Apparatus according to claim 4 wherein the lower zone includes a feed thereinto for liquid solvent/extract mixture; a heat source for heating the liquid solvent/extract mixture to evaporate the solvent from the extract; and a drain for draining liquid extract out of the condenser/evaporator vessel.

6. Apparatus according to claim 5 wherein the heat source is or includes a heating jacket or a member secured onto or surrounding a portion of the exterior of the condenser/evaporator vessel adjacent or corresponding to the lower zone.

7. Apparatus according to claim 4, wherein the upper zone includes a cooler that cools one or more surfaces in the upper zone; a receptacle lower than the surface and located to catch liquid solvent, condensed onto the surface, that falls from the surface under gravity; and a drain for draining liquid solvent from the receptacle.

8. Apparatus according to claim 7 wherein the cooler includes a jacket or member secured onto or surrounding a portion of the exterior of the vessel adjacent or corresponding to the upper zone, an interior wall of the upper zone, cooled by the cooling jacket or member, being or including the said surface and the receptacle including a tray protruding from the said wall inside the vessel.

9. Apparatus according to claim 8 wherein the upper zone is of cylindrical cross-section and the tray is an annulus protruding from and extending about the interior wall of the upper zone.

10. Apparatus according to claim 7 wherein the cooler includes a cooling member within the upper zone; the cooling member including the said surface; and the receptacle underlying the cooling member.

11. Apparatus according to claim 7 wherein the cooling jacket or member includes one or more internal passages permitting the flow therethrough of a cooling fluid.

12. Apparatus according to claim 7 wherein the drain passes through a wall of the evaporator/condenser vessel and wherein the closed loop circuit includes the lower zone, the upper zone and the drain, operatively connected in series.

13. Apparatus according to claim 4 wherein the lower and upper zones are spaced from one another by a gas permeable, generally liquid impermeable barrier.

14. Apparatus according to claim 5 wherein the heat source is or includes a heating member within the condenser/evaporator vessel.

15. Apparatus according to claim 3, including a direct heat pump for evaporating and condensing the solvent.

16. Apparatus according to claim 1 wherein the means for moving liquid solvent from the condenser to the extraction vessel includes a liquid pump operatively connected in series in the closed loop circuit between the condenser and the extraction vessel.

17. Apparatus according to claim 1 wherein the condenser is at a greater altitude than the extraction vessel and the evaporator, whereby the means for moving liquid solvent between the condenser and the extraction vessel includes the hydrostatic head between the condenser and the extraction vessel.

18. Apparatus according to claim 17 wherein the outlet of the condenser includes a liquid lute operatively connected in series therewith.

19. A method of extracting biomass comprising the steps of:
loading a bed of biomass into an extraction vessel having an inlet and an outlet and forming part of a closed loop circuit including, operatively connected in series, the extraction vessel, an evaporator and a condenser;
contacting the biomass with a solvent flowing around the closed loop, whereby biomass extract becomes entrained with the solvent;
moving the solvent around the closed loop to the evaporator and evaporating the solvent to separate the solvent and the extract from one another;
moving the vaporised solvent around the closed loop to the condenser and condensing it to liquid form; and
moving the condensed solvent around the closed loop to the extraction vessel for further contact with biomass therein, wherein the solvent in vapour form is generally uncompressed

20. A method according to claim 19 including the step of allowing the condensed, liquid solvent to move under gravity between the condenser and the extraction vessel.

21. A method according to claim 19 wherein the steps of evaporating and condensing the solvent take place within the same hollow vessel.

22. A method according to claim 21 including the step of operating a direct heat pump to effect the said evaporating and condensing.

23. A method according to claim 19 including the step of packing the biomass in the extraction vessel.

24. A method according to claim 19 including the step of removing biomass extract from the evaporator.
